(19) United States
(12) Patent Application Publication
(10) Pub. No.: US 2025/0005760 A1
(43) Pub. Date: Jan. 2, 2025

(54) SYSTEM AND METHOD OF DETECTING BUBBLES

(71) Applicant: Beckman Coulter, Inc., Brea, CA (US)

(72) Inventors: Shinya Matsuyama, Shizuoka (JP); Takayuki Mizutani, Edina, MN (US)

(21) Appl. No.: 18/758,480

(22) Filed: Jun. 28, 2024

Related U.S. Application Data
(63) Continuation of application No. PCT/IB2022/062313, filed on Dec. 15, 2022.
(60) Provisional application No. 63/294,385, filed on Dec. 29, 2021.

(51) Int. Cl. G06T 7/00; G01N 35/02; G01N 35/10; G06V 10/74

(52) U.S. Cl. CPC G06T 7/0016; G01N 35/026; G01N 35/1016; G06V 10/74; G01N 2035/1018; G01N 2035/1025

(57) ABSTRACT

The present disclosure provides a method of detecting bubbles in a sample liquid disposed in a container. The method comprises capturing a first image of the container at a first time instance; capturing a second image of the container at a second time instance after the first time instance; comparing the first image with the second image to determine a pattern matching score; and determining a presence of bubbles in the sample liquid if the pattern matching score crosses a predetermined threshold score.

### CROSS-REFERENCE TO RELATED APPLICATIONS

This is a continuation of, and claims the benefit of, international application PCT/IB2022/062313, entitled “System and Method of Detecting Bubbles,” filed Dec. 15, 2022, which itself is related to, and claims the benefit of, provisional patent application No. 63/294,385, entitled “System and Method of Detecting Bubbles,” filed Dec. 29, 2021, in the United States Patent Office, each of which applications are hereby incorporated by reference in their entirety.

### FIELD

The present disclosure generally relates to bubble detection in a sample liquid. Particularly, the present disclosure relates to a system and a method of detecting bubbles in a sample liquid disposed in a container. The present disclosure also relates to an automated analyzer comprising a system for detecting bubbles in a sample liquid.

### BACKGROUND

Clinical analyzers and/or immunoassays are well known in the art and are generally used for automated or semi-automated analysis of patient samples, such as blood, urine, spinal fluid, and the like. For testing and analyzing a patient sample, a specific component (i.e., an antigen) is measured in the patient sample. Analysis of the patient sample involve general procedures, such as aspirating the patient sample from a sample vessel, dispensing the patient sample into a reaction vessel, aspirating a reagent from a reagent pack, dispensing the reagent into the reaction vessel, and so on. All such procedures are conducted by using one or more probes. Finally, an amount of luminescence is measured from a mixture of the patient sample and the reagent in the reaction vessel.

For all the aspirating and dispensing procedures, it is important that the patient sample and/or the reagent are aspirated and dispensed according to predetermined amounts. Any inaccurate aspirating/dispensing operation may lead to an erroneous result of the analyzer. In some cases, bubbles are present on top of a sample liquid (i.e., the patient sample or the reagent). Generally, for aspirating the sample liquid, the probe is slightly immersed with its probe tip into the sample liquid to aspirate a given amount of the sample liquid. If the bubbles are present in the sample liquid, the probe may also aspirate one or more bubbles during pipetting of the sample liquid. Thus, an actual amount of the sample liquid aspirated by the probe may differ from the predetermined amount of the sample liquid that is intended to be aspirated. Further, due to presence of bubbles, the probe may dispense an inaccurate amount of the sample liquid into the reaction vessel. Hence, due to presence of bubbles, the inaccurate amount of the sample liquid in an aspiration/dispensing operation may lead to incorrect analysis of the patient sample. The incorrect analysis of the patient sample may further lead to serious problems during the course of treatment of the patient.

In an aspiration operation, it is common to detect a surface level of the sample liquid and then suck the sample liquid near the surface level. However, if the bubbles are present in the sample liquid, there may be a false detection of the surface level of the sample liquid. In other words, the bubbles may be mistaken as the surface level of the sample liquid, and the probe may perform suction without even touching the sample liquid. In some cases, due to presence of bubbles in the sample liquid, the suction may start from a position that is not an actual surface level of the sample liquid. This may lead to air suction and eventually incorrect dispensing amount of the sample liquid in the reaction vessel. The presence of bubbles in the sample liquid may lead to pipetting and sampling errors, and negatively impact a test result indicative of the analysis of the patient sample. Due to presence of bubbles and eventually incorrect aspiration/dispensing, conventional analyzers may generate false test results (i.e., false negatives or false positives). Further, an analyst may not be able to determine if the test result of the patient sample is a correct test result or an incorrect test result.

One of the conventional techniques to determine the presence of bubbles in the sample liquid is to measure pressure in a flow passage of the probe during an aspiration/dispensing operation. The pressure measurement may be indicative of inaccurate aspiration/dispensing. However, the pressure measurement technique is an indirect way of determining the presence of bubbles in the sample liquid and may therefore provide a reduced accuracy while detecting the bubbles. Another conventional method involves manual inspection, for the presence of bubbles or foam, every time before an aspiration/dispensing operation. Moreover, in some cases, an operator manually inspects the sample for the presence of bubbles upon determination of abnormal test results. The manual inspection methods may impose quality concerns over the detection of bubbles in the sample liquid. Further, the manual inspection may be time consuming and act as an additional work for an operator. This may further reduce a throughput of the analyzer performing the analysis of the patient sample.

### BRIEF SUMMARY

According to a first aspect of the disclosure, a method of detecting bubbles in a sample liquid disposed in a container for use in an automated analyzer is provided. The method comprises capturing, using an image capture device, a first image of the container at a first time instance. The method further comprises capturing, using the image capture device, a second image of the container at a second time instance after the first time instance. The method further comprises comparing, using a processor, the first image with the second image to determine a pattern matching score. The method further comprises determining, using the processor, a presence of bubbles in the sample liquid if the pattern matching score crosses a predetermined threshold score.

According to an embodiment of the method of the first aspect, the method further comprises determining, using the processor, an absence of bubbles in the sample liquid if the pattern matching score does not cross the predetermined threshold score.

According to an embodiment of the method of the first aspect, the presence of bubbles in the sample liquid is determined if the pattern matching score is greater than or equal to the predetermined threshold score. The absence of bubbles in the sample liquid is determined if the pattern matching score is less than the predetermined threshold score.

According to an embodiment of the method of the first aspect, the presence of bubbles in the sample liquid is determined if the pattern matching score is less than or equal to the predetermined threshold score. The absence of bubbles in the sample liquid is determined if the pattern matching score is greater than the predetermined threshold score.

According to an embodiment of the method of the first aspect, the method further comprises aspirating, using a probe, a portion of the sample liquid upon determining the absence of bubbles in the sample liquid.

According to an embodiment of the method of the first aspect, the method further comprises performing a bubble deforming procedure to deform the bubbles in the sample liquid. The bubble deforming procedure comprises agitating the sample liquid.

According to an embodiment of the method of the first aspect, agitating the sample liquid further comprises vibrating, using a vibrating mechanism, the container.

According to an embodiment of the method of the first aspect, agitating the sample liquid further comprises blowing, using a fluid delivery mechanism, a gaseous fluid into the sample liquid.

According to an embodiment of the method of the first aspect, the bubble deforming procedure is performed after the first time instance and before the second time instance.

According to an embodiment of the method of the first aspect, the method further comprises performing a bubble removing procedure to remove the bubbles in the sample liquid.

According to an embodiment of the method of the first aspect, the bubble removing procedure further comprises moving a sample probe to contact a surface of the sample liquid upon determining the presence of bubbles in the sample liquid.

According to an embodiment of the method of the first aspect, the method further comprises moving, without aspirating the sample liquid, the sample probe away from the surface of the sample liquid after performing the bubble removing procedure. The method further comprises moving the sample probe to contact the surface of the sample liquid to sense a level of the sample liquid. The method further comprises aspirating, using the sample probe, at least a portion of the sample liquid from the container after sensing the level of the sample liquid.

According to an embodiment of the method of the first aspect, the method further comprises capturing, using the image capture device, a third image of the container at a third time instance after the second time instance. The method further comprises comparing, using the processor, the first image, the second image, and the third image with each other to determine a multi-image pattern matching score. The method further comprises determining, using the processor, the presence of bubbles in the sample liquid if each of the pattern matching score and the multi-image pattern matching score crosses the predetermined threshold score.

According to an embodiment of the method of the first aspect, the method further comprises providing, using an output device, an output indicative of the presence of bubbles in the sample liquid upon determining the presence of bubbles in the sample liquid.

According to an embodiment of the method of the first aspect, the output comprises a notification for an operator to manually check for the bubbles in the sample liquid.

According to an embodiment of the method of the first aspect, the output comprises a flagging result.

According to an embodiment of the method of the first aspect, the output comprises a notification to halt at least any operation of the automated analyzer comprising a use of the sample liquid.

According to an embodiment of the method of the first aspect, the first image of the container is captured at a first position of the container, and the second image of the container is captured at a second position of the container.

According to an embodiment of the method of the first aspect, the method further comprises moving, using a transport mechanism, the container from the first position to the second position spaced apart from the first position.

According to an embodiment of the method of the first aspect, the container is removably received in a rack. Moving the container from the first position to the second position further comprises moving, using the transport mechanism, the rack from the first position to the second position.

According to an embodiment of the method of the first aspect, moving the rack from the first position to the second position further comprises moving the rack along a lane.

According to an embodiment of the method of the first aspect, the transport mechanism comprises a shuttle that removably receives the rack therein. Moving the rack from the first position to the second position further comprises moving the shuttle from the first position to the second position.

According to an embodiment of the method of the first aspect, the image capture device is disposed on the shuttle.

According to an embodiment of the method of the first aspect, the method further comprises reading, using a reading device, an identifier associated with the container at the first position of the container.

According to an embodiment of the method of the first aspect, the method further comprises moving the image capture device between a first capture position corresponding to the first position of the container and a second capture position corresponding to the second position of the container.

According to an embodiment of the method of the first aspect, the first position is same as the second position.

According to a second aspect of the disclosure, a system for detecting bubbles in a sample liquid disposed in a container is provided. The system comprises an image capture device configured to capture an image of the container. The system further comprises a processor communicably coupled to the image capture device. The processor is configured to control the image capture device to capture a first image of the container at a first time instance. The processor is further configured to control the image capture device to capture a second image of the container at a second time instance after the first time instance. The processor is further configured to compare the first image with the second image to determine a pattern matching score. The processor is further configured to determine a presence of bubbles in the sample liquid if the pattern matching score crosses a predetermined threshold score.

According to an embodiment of the system of the second aspect, the processor is further configured to determine an absence of bubbles in the sample liquid if the pattern matching score does not cross the predetermined threshold score.

According to an embodiment of the system of the second aspect, the processor is further configured to determine the presence of bubbles in the sample liquid if the pattern matching score is greater than or equal to the predetermined threshold score. The processor is further configured to determine the absence of bubbles in the sample liquid if the pattern matching score is less than the predetermined threshold score.

According to an embodiment of the system of the second aspect, the processor is further configured to determine the presence of bubbles in the sample liquid if the pattern matching score is less than or equal to the predetermined threshold score. The processor is further configured to determine the absence of bubbles in the sample liquid if the pattern matching score is greater than the predetermined threshold score.

According to an embodiment of the system of the second aspect, the system further comprises a probe configured to aspirate a portion of the sample liquid upon determining the absence of bubbles in the sample liquid.

According to an embodiment of the system of the second aspect, the system further comprises a bubble deforming unit configured to perform a bubble deforming procedure for deforming the bubbles in the sample liquid.

According to an embodiment of the system of the second aspect, the bubble deforming unit comprises a vibrating mechanism configured to vibrate the container. The vibrating mechanism vibrates the container to perform the bubble deforming procedure.

According to an embodiment of the system of the second aspect, the bubble deforming unit comprises a fluid delivery mechanism configured to discharge a gaseous fluid. The fluid delivery mechanism blows the gaseous fluid into the sample liquid to perform the bubble deforming procedure.

According to an embodiment of the system of the second aspect, the bubble deforming unit performs the bubble deforming procedure after the first time instance and before the second time instance.

According to an embodiment of the system of the second aspect, the system further comprises a bubble removing unit configured to perform a bubble removing procedure for removing the bubbles in the sample liquid.

According to an embodiment of the system of the second aspect, the bubble removing unit further comprises a sample probe configured to selectively aspirate the sample liquid from the container and a probe movement module configured to selectively move the sample probe. The probe movement module moves the sample probe to contact a surface of the sample liquid upon determining the presence of bubbles in the sample liquid. The sample probe contacts the surface of the sample liquid to perform the bubble removal procedure.

According to an embodiment of the system of the second aspect, the probe movement module moves, without aspiration of the sample liquid, the sample probe away from the surface of the sample liquid after the sample probe performs the bubble removal procedure. The probe movement module further moves the sample probe to contact the surface of the sample liquid, such that the sample probe senses a level of the sample liquid upon contact with the surface of the sample liquid. The sample probe further aspirates at least a portion of the sample liquid from the container after sensing the level of the sample liquid.

According to an embodiment of the system of the second aspect, the processor is further configured to control the image capture device to capture a third image of the container at a third time instance after the second time instance. The processor is further configured to compare the first image, the second image, and the third image with each other to determine a multi-image pattern matching score. The processor is further configured to determine the presence of bubbles in the sample liquid if each of the pattern matching score and the multi-image pattern matching score crosses the predetermined threshold score.

According to an embodiment of the system of the second aspect, the first image of the container is captured at a first position of the container, and the second image of the container is captured at a second position of the container.

According to an embodiment of the system of the second aspect, the system further comprises a transport mechanism configured to move the container from the first position to the second position spaced apart from the first position.

According to an embodiment of the system of the second aspect, the system further comprises a rack configured to removably receive the container therein and operatively coupled to the transport mechanism. The transport mechanism moves the rack from the first position to the second position in order to move the container from the first position to the second position.

According to an embodiment of the system of the second aspect, the transport mechanism further moves the rack from the first position to the second position along a lane.

According to an embodiment of the system of the second aspect, the transport mechanism comprises a shuttle that removably receives the rack therein. The shuttle moves the rack from the first position to the second position.

According to an embodiment of the system of the second aspect, the image capture device is disposed on the shuttle.

According to an embodiment of the system of the second aspect, the system further comprises a reading device configured to read an identifier associated with the container at the first position of the container.

According to an embodiment of the system of the second aspect, the system further comprises an image movement module configured to move the image capture device. The image movement module moves the image capture device between a first capture position corresponding to the first position of the container and a second capture position corresponding to the second position of the container.

According to an embodiment of the system of the second aspect, the first position is same as the second position.

According to a third aspect of the disclosure, an automated analyzer comprising the system of the second aspect is provided.

According to an embodiment of the automated analyzer of the third aspect, the automated analyzer comprises an immunoassay analyzer or a clinical chemistry analyzer.

According to an embodiment of the automated analyzer of the third aspect, the automated analyzer further comprises an output device communicably coupled to the processor. The processor is further configured to control the output device to provide an output indicative of the presence of bubbles in the sample liquid upon determining the presence of bubbles in the sample liquid.

According to an embodiment of the automated analyzer of the third aspect, the output comprises a notification for an operator to manually check for the bubbles in the sample liquid.

According to an embodiment of the automated analyzer of the third aspect, the output comprises a flagging result.

According to an embodiment of the automated analyzer of the third aspect, the output comprises a notification to halt at least any operation of the automated analyzer comprising a use of the sample liquid.

The system and the method of the present disclosure determines the absence or presence of bubbles in the sample liquid by comparing the first image with the second image (captured at different time instances) to determine the pattern matching score, and then further comparing the pattern matching score with the predetermined threshold score. Upon determining the presence of bubbles in the sample liquid, the operator is notified by the output device regarding the presence of bubbles in the sample liquid. The operator can then halt or disallow a corresponding aspiration/dispensing operation in the automated analysis of the sample liquid. Through bubble detection in the sample liquid, the system and the method of the present disclosure provides the operator with a timely output to take preventive measures as the automated analyzer may provide erroneous test results due to the presence of bubbles in the sample liquid. In other words, upon determining the presence of bubbles, the system and the method of the present disclosure may alert the operator to stop the current aspiration/dispensing operation to avoid any error in the analysis of the sample liquid.

The method of the present disclosure may also be implemented in the automated analyzer. In the system and method of the present disclosure, the operator receives the notification to manually check for the bubbles only when the bubbles are detected in the sample liquid. In other words, a manual inspection to check the bubbles is only required when the output device generates the corresponding notification upon determining the presence of bubbles. Therefore, as compared to the conventional analyzers where the operator had to manually check for bubbles every time prior to an aspiration/dispensing operation, the method of the present disclosure requires the operator to check for the bubbles only when the presence of bubbles is determined in the sample liquid. In contrast to the conventional methods, the proposed system and the method may help the operator to save a lot of time, since he/she may not need to check for bubbles if the absence of bubbles is determined in the sample liquid. This may further improve an efficiency of the operator as he/she is not required to manually check for bubbles every time prior to an aspiration/dispensing operation.

For determining the presence or absence of bubbles in the sample liquid, the method comprises comparing the first image with the second image to determine the pattern matching score. The method further comprises comparing the pattern matching score with the predetermined threshold score to determine the presence or absence of bubbles. As compared to the conventional pressure measurement technique for detecting bubbles, the method and the system of the present disclosure do not involve any pressure measurement associated with the aspirating/dispensing operation. As the proposed method comprises capturing two or more images of the sample liquid to detect the bubbles without any pressure measurement, the proposed system provides a direct way of determining the presence of bubbles in the sample liquid. Moreover, due to direct measurement technique, the system and the method of the present disclosure may determine the presence of bubbles in the sample liquid with improved precision and accuracy as compared to the conventional techniques and methods.

In addition to capturing the first image and the second image, the method of the present disclosure further comprises capturing the third image at the third time instance (after the second time instance) to determine the presence or absence of bubbles in the sample liquid. As shape of the bubbles changes with time, an additional image (i.e., the third image captured at the third time instance) taken into account for detecting the bubbles may further improve the accuracy of the method of bubble detection.

The bubble deforming unit further performs the bubble deforming procedure for deforming the bubbles in the sample liquid. The bubble deforming procedure may be performed after the first time instance and before the second time instance. The bubble deforming procedure may change the shape of the bubbles, thereby improving bubble detection by comparing the first image captured at the first time instance with the second image captured at the second time instance.

Further, upon determining the presence of bubbles in the sample liquid, the bubble removing unit removes the bubbles by using the sample probe and the probe movement module. The bubble removing unit selectively moves the sample probe to remove the bubbles as well as sense a level of the sample liquid. After a given time period, the bubble removing unit selectively moves the sample probe to again sense the level of the sample liquid. After performing the two stages of level sensing of the sample liquid, the method allows the required aspiration of the sample liquid from the container. Therefore, by removing the detected bubbles in the sample liquid, the system including the bubble removing unit may facilitate continuous operation of testing a number of liquid samples without any erroneous test results. Moreover, as the bubbles are removed by the sample probe during its first contact with the surface of the sample liquid, there is a minimal chance of a false level sensing of the sample liquid. The correct sensing of the level of the sample liquid may prevent the aspiration operation from including a pipetting error that could otherwise generate false test results of the sample liquid.

A variety of additional aspects will be set forth in the description that follows. These aspects can relate to individual features and to combinations of features. It is to be understood that both the foregoing summary and the following detailed description are exemplary and explanatory only and are not restrictive of the broad concepts upon which the embodiments disclosed herein are based.

### BRIEF DESCRIPTION OF THE FIGURES

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a block diagram of a system of an automated analyzer for detecting bubbles in a sample liquid, according to an embodiment of the present disclosure;

FIG. 2 is a schematic diagram of the system of FIG. 1, according to an embodiment of the present disclosure;

FIG. 3 is a schematic view of a container of the system of FIG. 2, according to an embodiment of the present disclosure;

FIG. 4 is a schematic view of the container of FIG. 3, according to another embodiment of the present disclosure;

FIG. 5 shows schematically the different images of the container of FIG. 3 captured at different time instances, according to an embodiment of the present disclosure;

FIG. 6 is a flowchart of a process to detect bubbles in the sample liquid disposed in the container of FIG. 3, according to an embodiment of the present disclosure;

FIG. 7 is a flowchart of a process to detect bubbles in the sample liquid disposed in the container of FIG. 3, according to another embodiment of the present disclosure;

FIGS. 8A-8D are schematic views of the container of FIG. 3 and a bubble removing unit of the system of FIG. 2, according to an embodiment of the present disclosure;

FIG. 9 is a flowchart of a process to detect bubbles in the sample liquid disposed in the container and to perform a bubble removing procedure by the bubble removing unit of FIG. 8A, according to an embodiment of the present disclosure;

FIGS. 10A and 10B are schematic views of the container and a bubble deforming unit of the system of FIG. 2, according to an embodiment of the present disclosure;

FIGS. 11A and 11B are schematic views of the container and a bubble deforming unit of the system of FIG. 2, according to another embodiment of the present disclosure;

FIG. 12 is a flowchart of a process to detect bubbles in the sample liquid disposed in the container and to perform a bubble deforming procedure by the bubble deforming units of FIGS. 10A and 11A, according to an embodiment of the present disclosure;

FIG. 13 is a schematic diagram of a system of an automated analyzer for detecting bubbles in a sample liquid, according to an embodiment of the present disclosure;

FIG. 14 is a flowchart illustrating a method of detecting bubbles in the sample liquid disposed in the container of FIG. 3, according to an embodiment of the present disclosure;

FIG. 15 shows two images of the container captured at different time instances during an experiment for detection of bubbles in a sample liquid;

FIG. 16 shows three images of the container captured at different time instances during an experiment for detection of bubbles in a sample liquid; and

FIG. 17 shows three images of the container captured at different time instances during another experiment for detection of bubbles in a sample liquid.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

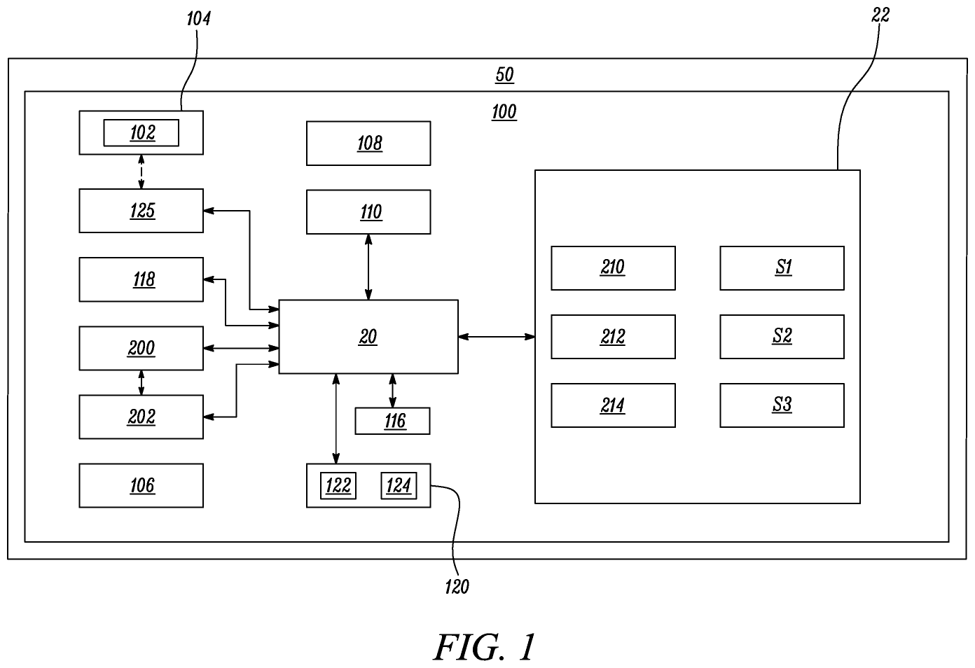

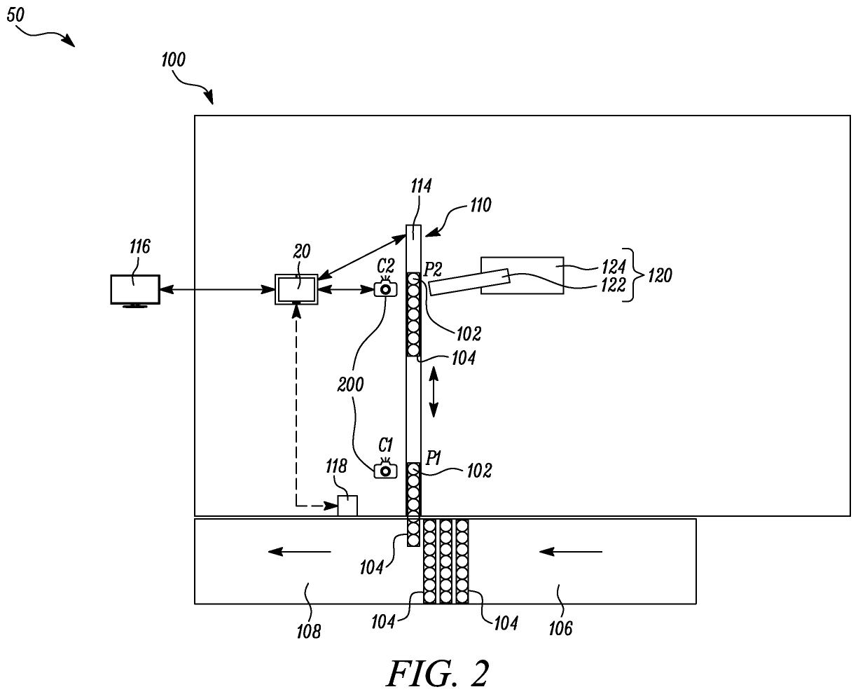

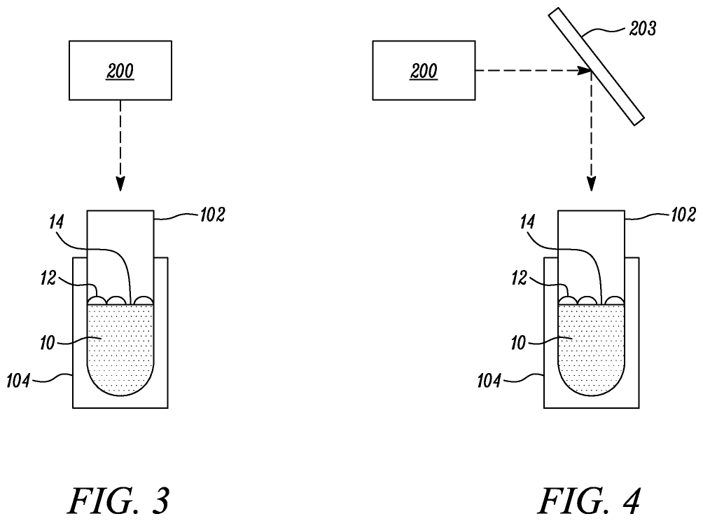

Referring now to Figures, FIG. 1 is a block diagram of a system 100 of an automated analyzer 50 for detecting bubbles 12 (shown in FIG. 3) in a sample liquid 10 (shown in FIG. 3) disposed in a container 102. FIG. 2 is a schematic diagram of the system 100 of FIG. 1. Some components of the system 100 are not shown in FIG. 2 for illustrative purposes. FIG. 3 is a schematic view of the container 102 containing the sample liquid 10. In the illustrated embodiment of FIG. 2, the automated analyzer 50 is an immunoassay analyzer.

With reference to FIGS. 1 to 3, the container 102 may be a vessel or a culture bottle. The sample liquid 10 may be a bodily fluid, such as blood, serum, plasma, blood fractions, joint fluid, urine, and other body fluids. In some cases, the sample liquid 10 may be a reagent. In some cases, the sample liquid may be a mixture of the reagent, a biological sample, and a diluent. As shown in FIG. 3, the bubbles 12 are present in the sample liquid 10. Specifically, the bubbles 12 are present on a surface 14 of the sample liquid 10. In some embodiments, the system 100 includes a rack 104 configured to removably receive the container 102 therein. In other words, the container 102 is removably received in the rack 104. In the illustrated embodiment of FIG. 2, the system includes a plurality of racks 104, and each rack 104 is configured to receive a plurality of containers 102 therein.

The system 100 includes an image capture device 200 configured to capture an image of the container 102. In some embodiments, the image capture device 200 is movably disposed in the system 100, which can move either independently from other components of the system 100 or together with one or more components of the system 100. In some embodiments, the image capture device 200 includes a camera. In some embodiments, the image capture device 200 may include one or more image sensors. In the illustrated embodiment of FIGS. 1 and 2, the system 100 includes only one image capture device 200. However, in other embodiments, the system 100 may include two or more image capture devices. The image capture device 200 is configured to capture the image of the container 102 from a top of the container 102. Specifically, the image capture device 200 is configured to capture the image of the container 102, such that at least the surface 14 of the sample liquid 10 is captured in the image.

The system 100 further includes a processor 20 communicably coupled to the image capture device 200. The processor 20 may be a programmable analog and/or digital device that can store, retrieve, and process data. In an application, the processor 20 may be a controller, a control circuit, a computer, a workstation, a microprocessor, a microcomputer, a central processing unit, a server, or any suitable device or apparatus. The processor 20 is communicably coupled to a memory 22 of the system 100.

In some cases, the system 100 may include a screen (not shown) spaced apart from the image capture device 200, such that the container 102 is positioned between the image capture device 200 and the screen. The screen is used to cast light back in the direction of a field of view (FOV) of the image capture device 200 by reflecting the light toward an aperture (not shown) of the image capture device 200. The screen may be made of one or more various materials which can provide different reflection intensities. In some cases, the screen can be replaced by a light source (not shown), such that the container 102 is positioned between the image capture device 200 and the light source. The light source is used to illuminate the container 102 and its surroundings to be photographed as desired. In some cases, the system 100 may include both the screen and the light source.

FIG. 4 is a schematic view of the container 102 containing the sample liquid 10, according to another embodiment of the present disclosure. In this embodiment, a mirror 203 is positioned between the container 102 and the image capture device 200, such that light rays from the container 102 are reflected by the mirror 203 towards the image capture device 200. In some cases, a position and/or orientation of the mirror 203 may be adjustable based on respective positions and/or orientations of the container 102 and/or the image capture device 200.

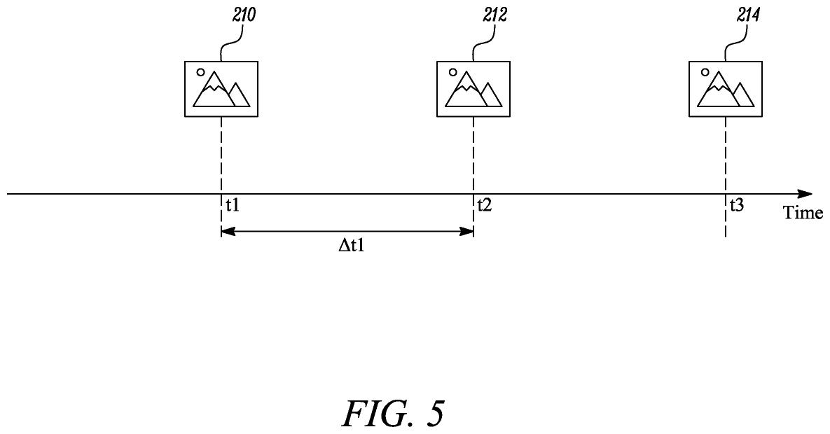

With reference to FIGS. 1 to 3, the processor 20 is configured to control the image capture device 200 to capture a first image 210 of the container 102 at a first time instance t1 (shown in FIG. 5). The processor 20 is configured to control the image capture device 200 to capture a second image 212 of the container 102 at a second time instance t2 (shown in FIG. 5) after the first time instance t1. In some embodiments, the first image 210 and the second image 212 are captured at different positions of the container 102. In some embodiments, the first image 210 and the second image 212 are captured at a single position of the container 102. The first image 210 and the second image 212 are stored in the memory 22. Each of the first image 210 and the second image 212 may be a grayscale digital image and/or a color image.

In the illustrated embodiment of FIG. 2, the first image 210 of the container 102 is captured at a first position P1 of the container 102 at the first time instance t1. Further, the second image 212 of the container 102 is captured at a second position P2 of the container 102 at the second time instance t2. The second position P2 of the container 102 is spaced apart from the first position P1 of the container 102. In some other embodiments, the first position P1 of the container 102 is same as the second position P2 of the container 102. In other words, the first and second images 210, 212 are captured at a single location of the container 102 at different time instances.

The system 100 further includes a transport mechanism 110 configured to move the container 102 from the first position P1 to the second position P2 spaced apart from the first position P1. The processor 20 is communicably coupled to the transport mechanism 110. The rack 104 is operatively coupled to the transport mechanism 110. Therefore, as the rack 104, that removably receives the container 102, is operatively coupled to the transport mechanism 110, the transport mechanism 110 moves the rack 104 from the first position P1 to the second position P2 in order to move the container 102 from the first position P1 to the second position P2. Further, the transport mechanism 110 moves the rack 104 along a lane 114 in order to move the rack 104 from the first position P1 to the second position P2.

Before moving the rack 104 from the first position P1 to the second position P2, the rack 104 may be transported to the transport mechanism 110 from a rack loading unit 106 by a robotic arm or a positioner unit (not shown). The rack 104 may be further transported from the lane 114 to a rack unloading unit 108. In some cases, the transport mechanism 110 may include a track with conveyor belts (not shown) along the lane 114, such that the transport mechanism 110 moves the rack 104 from one position to another position. In some cases, the transport mechanism 110 may include a chain, a carriage, a lead screw, a linear motor, or combinations thereof, such that the transport mechanism 110 moves the rack 104 from one position to another position. In some cases, the transport mechanism 110 may include a motor (stepper motor or servo motor) to move the rack along the lane 114. Thus, the transport mechanism 110 is configured to move the rack 104 along the lane 114. At the first position P1 of the container 102, the first image 210 is captured by the image capture device 200 at the first time instance t1.

In some embodiments, the system 100 further includes a reading device 118 configured to read an identifier associated with the container 102 at the first position P1 of the container 102. In some embodiments, the reading device 118 may be disposed adjacent to the first position P1 of the container 102. In some embodiments, the reading device 118 may be disposed at an end of the lane 114 proximal to the first position P1 of the container 102. In some cases, the reading device 118 may include an ID (identity document) information reader which reads the identifier associated with the container 102. In some cases, the identifier associated with the container 102 may include a bar code attached on the container 102. Therefore, the reading device 118 (i.e., the ID information reader) reads the identifier (or bar code) associated with the container 102 and inputs the read information to the processor 20. In some embodiments, the reading device 118 may also read an identifier associated with the rack 104. In some cases, the identifier associated with the rack 104 may include a bar code disposed on the rack 104. The bar code of the rack 104 may include information regarding its rack serial number, shape, and number of containers placed in the rack 104. The bar code of the container 102 may include information regarding its sample, for example, serial number, size, shape, date of entry, name and entry number of patient, sample species, analysis items requested, and the like.

After the first image 210 is captured at the first position P1 and at the first time instance t1, the transport mechanism 110 moves the rack 104 from the first position P1 to the second position P2. In other words, after the first image 210 is captured at the first position P1 and at the first time instance t1, the transport mechanism 110 moves the rack 104 and the container 102 from the first position P1 to the second position P2 along the lane 114.

In some embodiments, the system 100 further includes an image movement module 202 (shown in FIG. 1) configured to move the image capture device 200. The image movement module 202 moves the image capture device 200 between a first capture position C1 corresponding to the first position P1 of the container 102 and a second capture position C2 corresponding to the second position P2 of the container 102. The image movement module 202 may include a motorized unit (not shown) to control the movement of the image capture device 200. Further, the processor 20 is communicably coupled to the image movement module 202 and controls the operation of the image movement module 202.

At the second position P2 of the container 102, the second image 212 is captured by the image capture device 200 at the second time instance t2. The processor 20 is further configured to compare the first image 210 with the second image 212 to determine a pattern matching score S1. The pattern matching score S1 may be a measure of the degree to which the second image 212 matches the first image 210. Pattern matching between the first image 210 and the second image 212 may be performed by using Zero mean Normalized Cross-Correlation function (ZNCC), normalized correlation technique, Hough conversion technique, or other image processing functions. The pattern matching score S1 is used by the processor 20 to determine a presence or an absence of bubbles 12 in the sample liquid 10. Specifically, the processor 20 is configured to determine the presence of bubbles 12 (shown in FIG. 3) in the sample liquid 10 if the pattern matching score S1 crosses a predetermined threshold score S2 (shown in FIG. 1). Further, the processor 20 is configured to determine the absence of bubbles 12 in the sample liquid 10 if the pattern matching score S1 does not cross the predetermined threshold score S2. A process illustrating the steps for determining the presence or the absence of bubbles 12 in the sample liquid 10 will be described herein later.

The automated analyzer 50 or the system 100 further includes an output device 116 communicably coupled to the processor 20. The processor 20 is further configured to control the output device 116 to provide an output indicative of the presence of bubbles 12 in the sample liquid 10 upon determining the presence of bubbles 12 in the sample liquid 10. In some embodiments, the output device 116 may include a speaker, a monitor, a messaging unit, an audio-visual unit, or combinations thereof. In some embodiments, the output device 116 may be an external unit that is not a part of the automated analyzer 50.

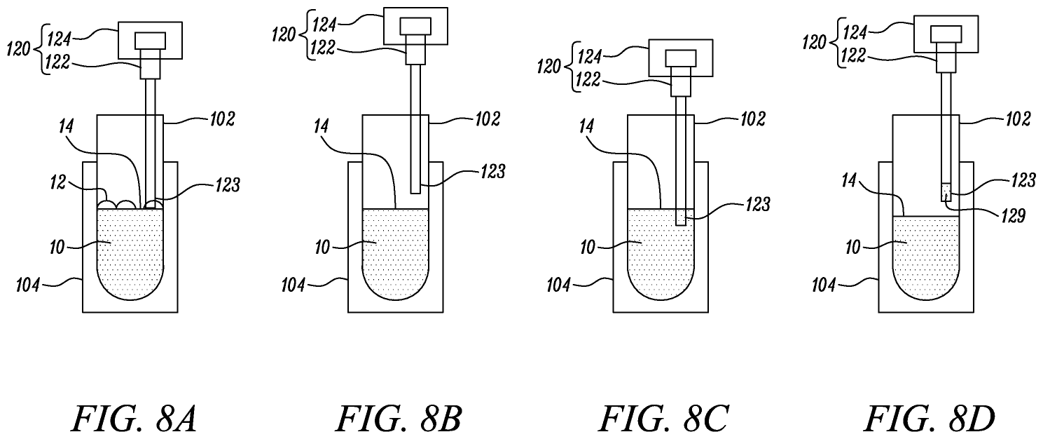

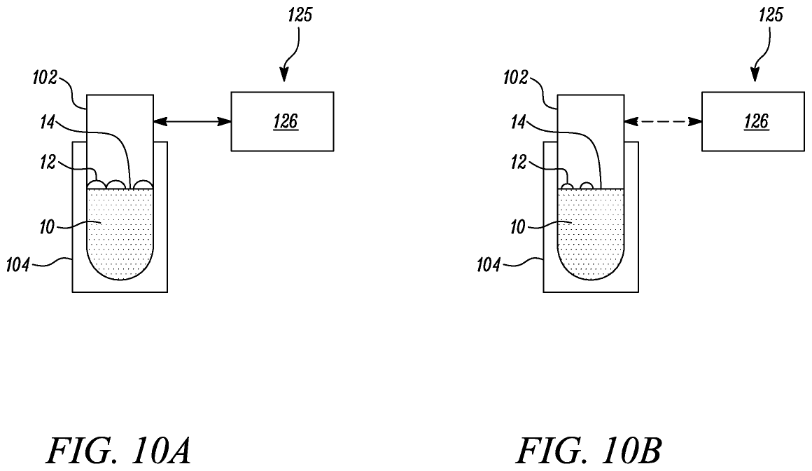

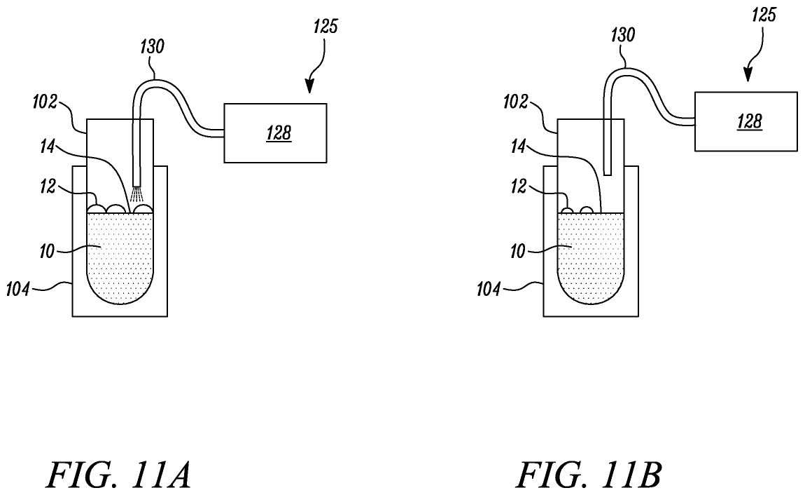

The system 100 further includes a bubble removing unit 120 (shown in FIGS. 8A to 8D) and a bubble deforming unit 125 (shown in FIGS. 10A to 11B) which will be described herein later. The automated analyzer 50 may also include other components, such as feeder units, a wash wheel, a pipettor pump, reagent bottles, a reagent disk, a reaction vessel, etc. These components are not shown in FIGS. 1 and 2 for illustrative purposes.

FIG. 5 shows schematically the different images of the container 102 (shown in FIG. 3) captured at different time instances, according to an embodiment of the present disclosure. As illustrated, the first image 210 is captured at the first time instance t1 and the second image 212 is captured at the second time instance t2. A time period between the first time instance t1 and the second time instance t2 is illustrated as a time period Δt1. In some cases, the time period Δt1 is from about 10 milliseconds to 10 seconds.

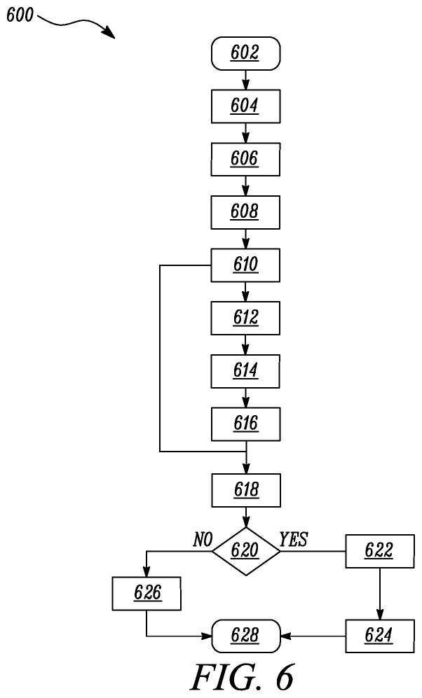

FIG. 6 is a flowchart of a process 600 to detect the bubbles 12 in the sample liquid 10 disposed in the container 102 (shown in FIG. 3), according to an embodiment of the present disclosure. The process 600 is embodied as a machine vision algorithm or a machine learning algorithm implemented by the system 100 (shown in FIGS. 1 and 2) including the processor 20. Further, the process 600 may be stored in the memory 22.

At operation 602, the process 600 begins. Referring now to FIGS. 1 to 6, at operation 604, the rack 104 is loaded with the container 102 containing the sample liquid 10. The process 600 moves to operation 606. At the operation 606, the processor 20 controls the transport mechanism 110 (shown in FIG. 2) to move the rack 104 and the container 102 to the first position P1. The process 600 further moves to operation 608.

At the operation 608, the processor 20 controls the image movement module 202 (shown in FIG. 1) to move the image capture device 200 to the first capture position C1 corresponding to the first position P1 of the container 102. The process 600 further moves to operation 610.

At the operation 610, the processor 20 controls the image capture device 200 to capture the first image 210 of the container 102 at the first time instance t1 (shown in FIG. 5). As already stated above, the first image 210 of the container 102 is captured from the top of the container 102. The process 600 further moves to operation 612.

At the operation 612, the processor 20 controls the transport mechanism 110 to move the rack 104 and the container 102 from the first position P1 to the second position P2. The process 600 further moves to operation 614. At the operation 614, the processor 20 controls the image movement module 202 to move the image capture device 200 from the first capture position C1 to the second capture position C2 corresponding to the second position P2 of the container 102. The operations 612 and 614 may occur simultaneously or with a certain degree of overlap. The process 600 further moves to operation 616.

At the operation 616, the processor 20 controls the image capture device 200 to capture the second image 212 of the container 102 at the second time instance t2 (shown in FIG. 5) after the first time instance t1. As already stated above, the second image 212 of the container 102 is captured from the top of the container 102. In a case where the first position P1 is same as the second position P2, the operations 612 and 614 may not take place, and then the operation 614 involves capturing the second image 212 at the first position P1 and at the second time instance t2. The process 600 further moves to operation 618.

At the operation 618, the processor 20 compares the first image 210 with the second image 212 to determine the pattern matching score S1. The process 600 further moves to operation 620. At the operation 620, the processor 20 compares the pattern matching score S1 with the predetermined threshold score S2 (shown in FIG. 1). Specifically, at the operation 620, the processor 20 checks if the pattern matching score S1 crosses the predetermined threshold score S2. If the pattern matching score S1 does not cross the predetermined threshold score S2, the process 600 moves to operation 626.

At the operation 626, the processor 20 determines the absence of bubbles 12 in the sample liquid 10. Thus, due to the absence of bubbles 12 in the sample liquid 10 disposed in the container 102, the sample liquid 10 may be aspirated and considered appropriate for use in the automated analyzer 50. In some embodiments, the system 100 further includes a probe 122 (shown in FIGS. 1 and 2) configured to aspirate a portion of the sample liquid 10 upon determining the absence of bubbles 12 in the sample liquid 10. The aspirated amount of the sample liquid 10 may be further used to analyze a patient sample. In some embodiments, the probe 122 can be interchangeably referred to herein as “a sample probe 122”. Further, the process 600 moves to operation 628 where the process 600 is terminated.

At the operation 620, if the pattern matching score S1 crosses the predetermined threshold score S2, the process 600 moves to operation 622. At the operation 622, the processor 20 determines the presence of bubbles 12 in the sample liquid 10. Thus, due to the presence of bubbles 12 in the sample liquid 10 disposed in the container 102, the sample liquid 10 may be considered inappropriate for use in the automated analyzer 50. The process 600 further moves to operation 624.

At the operation 624, the processor 20 controls the output device 116 to provide an output indicating the presence of bubbles 12 in the sample liquid 10. In some embodiments, the output includes a notification for an operator to manually check for the bubbles 12 in the sample liquid 10. In some embodiments, the output includes a flagging result (e.g., error flag). In some embodiments, the output includes a notification to halt at least any operation of the automated analyzer 50 comprising a use of the sample liquid 10. Such operations may include an upcoming aspiration operation, an upcoming dispensing operation, an ongoing analysis of a patient sample comprising the sample liquid 10 aspirated in a previous cycle, and the like. The notification may include a visual alert, a text message, an audible signal, an alarm, or combinations thereof. After providing the output, the process 600 moves to the operation 628 where the process 600 is terminated.

In some cases, at the operation 620, the logic can be programmed such that the term “pattern matching score S1 crosses the predetermined threshold score S2” means that the pattern matching score S1 is greater than or equal to the predetermined threshold score S2. Therefore, in some embodiments, the processor 20 is configured to determine the presence of bubbles 12 in the sample liquid 10 if the pattern matching score S1 is greater than or equal to the predetermined threshold score S2. Similarly, based on this logic, the processor 20 is configured to determine the absence of bubbles 12 in the sample liquid 10 if the pattern matching score S1 is less than the predetermined threshold score S2.

In other cases, at the operation 620, the logic can be programmed such that the term “pattern matching score S1 crosses the predetermined threshold score S2” means that the pattern matching score S1 is less than or equal to the predetermined threshold score S2. Therefore, in some embodiments, the processor 20 is configured to determine the presence of bubbles 12 in the sample liquid 10 if the pattern matching score S1 is less than or equal to the predetermined threshold score S2. Similarly, based on this logic, the processor 20 is configured to determine the absence of bubbles 12 in the sample liquid 10 if the pattern matching score S1 is greater than the predetermined threshold score S2.

The system 100 including the processor 20 determines the absence or presence of bubbles 12 in the sample liquid 10 by comparing the first image 210 with the second image 212 (captured at different time instances) to determine the pattern matching score S1, and then further comparing the pattern matching score S1 with the predetermined threshold score S2. Upon determining the presence of bubbles 12 in the sample liquid 10, the operator is notified by the output device 116 regarding the presence of bubbles 12. The operator can then halt or disallow a corresponding aspiration/dispensing operation in the automated analysis of the sample liquid 10. Through bubble detection in the sample liquid 10, the system 100 provides the operator a timely output to take preventive measures before the automated analyzer 50 provides a test result that could be erroneous. In other words, upon determining the presence of bubbles 12, the system 100 including the processor 20 may alert the operator to stop the current aspiration/dispensing operation to avoid any error in the analysis of the sample liquid 10.

Through the process 600, the operator receives the notification to manually check for the bubbles 12 only when the bubbles 12 are detected in the sample liquid 10. In other words, a manual inspection to check the bubbles 12 is required only when the output device 116 generates the corresponding notification upon determining the presence of bubbles 12. Therefore, as compared to conventional analyzers where an operator had to manually check for bubbles every time prior to an aspiration/dispensing operation, the process 600 requires the operator to check for the bubbles 12 only when the presence of bubbles 12 is determined in the sample liquid 10. In contrast to conventional techniques of bubble detection, the proposed system 100 may help the operator to save a lot of time, since he/she may not need to check for the bubbles 12 if the absence of bubbles 12 is determined in the sample liquid 10. This may further improve an efficiency of the operator as he/she is not required to manually check for bubbles every time prior to an aspiration/dispensing operation.

For determining the presence or absence of bubbles 12 in the sample liquid 10, the processor 20 compares the first image 210 with the second image 212 to determine the pattern matching score S1. The processor 20 further determines the presence or absence of bubbles 12 by comparing the pattern matching score S1 with the predetermined threshold score S2. As compared to conventional pressure measurement techniques for detecting bubbles, the system 100 including the processor 20 do not involve any pressure measurement associated with the aspirating/dispensing operation. As the process 600 comprises capturing the first image 210 and the second image 212 to detect the bubbles 12 without any pressure measurement, the proposed system 100 provides a direct way of determining the presence or absence of bubbles 12 in the sample liquid 10. Moreover, due to direct measurement technique, the system 100 including the processor 20 may determine the presence of bubbles 12 in the sample liquid 10 with improved precision and accuracy as compared to the conventional techniques and methods.

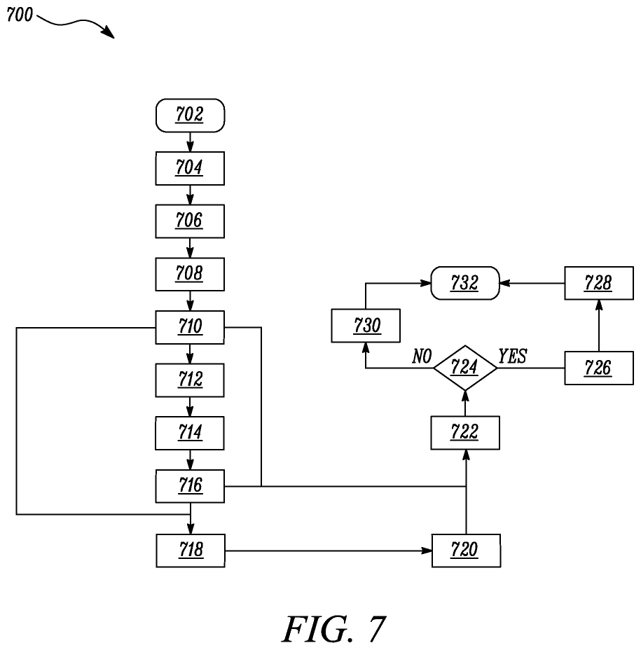

FIG. 7 is a flowchart of a process 700 to detect the bubbles 12 in the sample liquid 10 disposed in the container 102 (shown in FIG. 3), according to an embodiment of the present disclosure. The process 700 is embodied as a machine vision algorithm or a machine learning algorithm implemented by the system 100 (shown in FIGS. 1 and 2) including the processor 20. Further, the process 700 may be stored in the memory 22.

At operation 702, the process 700 begins. In the process 700, operations 704, 706, 708, 710, 712, 714, 716, and 718 are same as the operations 604, 606, 608, 610, 612, 614, 616, and 618, respectively, of the process 600 of FIG. 6. After determining the pattern matching score S1 at the operation 718, the process 700 further moves to operation 720.

Referring to FIGS. 1 to 7, at the operation 720, the processor 20 is configured to control the image capture device 200 to capture a third image 214 of the container 102 at a third time instance t3 (shown in FIG. 5) after the second time instance t2. The third image 214 is also captured from the top of the container 102. In some embodiments, the third image 214 may be captured at a new position spaced apart from the second position P2 of the container 102. In such a case, the processor 20 initially controls the transport mechanism 110 to move the container 102 to the new position and then controls the image capture device 200 to capture the third image 214 of the container 102 at the new position and at the third time instance t3. The process 700 further moves to operation 722. In some cases, a time difference between the third time instance t3 and the second time instance t2 may be equal to Δt1.

At the operation 722, the processor 20 is configured to compare the first image 210, the second image 212, and the third image 214 with each other to determine a multi-image pattern matching score S3 (shown in FIG. 1). The process 700 further moves to operation 724. At the operation 724, the processor 20 compares each of the pattern matching score S1 (shown in FIG. 1) and the multi-image pattern matching score S3 with the predetermined threshold score S2 (shown in FIG. 1). Specifically, at the operation 724, the processor 20 checks if each of the pattern matching score S1 and the multi-image pattern matching score S3 crosses the predetermined threshold score S2. If at least one of the pattern matching score S1 and the multi-image pattern matching score S3 does not cross the predetermined threshold score S2, the process 700 moves to operation 730.

At the operation 730, the processor 20 determines the absence of bubbles 12 in the sample liquid 10. Therefore, the processor 20 is configured to determine the absence of bubbles 12 in the sample liquid 10 if at least one of the pattern matching score S1 and the multi-image pattern matching score S3 does not cross the predetermined threshold score S2. Further, the process 700 moves to operation 732 where the process 700 is terminated.

At the operation 724, if each of the pattern matching score S1 and the multi-image pattern matching score S3 crosses the predetermined threshold score S2, the process 700 moves to operation 726. At the operation 726, the processor 20 determines the presence of bubbles 12 in the sample liquid 10. Therefore, the processor 20 is configured to determine the presence of bubbles 12 in the sample liquid 10 if each of the pattern matching score S1 and the multi-image pattern matching score S3 crosses the predetermined threshold score S2. The process 700 further moves to operation 728.

At the operation 728, the processor 20 controls the output device 116 to provide an output indicating the presence of bubbles 12 in the sample liquid 10. The notification may include a visual alert, a text message, an audible signal, an alarm, or combinations thereof. After providing the output, the process 700 moves to the operation 732 where the process 700 is terminated.

In some cases, at the operation 724, the logic can be programmed such that the term “each of the pattern matching score S1 and the multi-image pattern matching score S3 crosses the predetermined threshold score S2” means that each of the pattern matching score S1 and the multi-image pattern matching score S3 is greater than or equal to the predetermined threshold score S2. Therefore, in some embodiments, the processor 20 is configured to determine the presence of bubbles 12 in the sample liquid 10 if each of the pattern matching score S1 and the multi-image pattern matching score S3 is greater than or equal to the predetermined threshold score S2. Similarly, based on this logic, the processor 20 is configured to determine the absence of bubbles 12 in the sample liquid 10 if at least one of the pattern matching score S1 and the multi-image pattern matching score S3 is less than the predetermined threshold score S2.

In some cases, at the operation 724, the logic can be programmed such that the term “each of the pattern matching score S1 and the multi-image pattern matching score S3 crosses the predetermined threshold score S2” means that each of the pattern matching score S1 and the multi-image pattern matching score S3 is less than or equal to the predetermined threshold score S2. Therefore, in some embodiments, the processor 20 is configured to determine the presence of bubbles 12 in the sample liquid 10 if each of the pattern matching score S1 and the multi-image pattern matching score S3 is less than or equal to the predetermined threshold score S2. Similarly, based on this logic, the processor 20 is configured to determine the absence of bubbles 12 in the sample liquid 10 if at least one of the pattern matching score S1 and the multi-image pattern matching score S3 is greater than the predetermined threshold score S2.

In addition to capturing the first image 210 and the second image 212, the process further controls the image capture device 200 to capture the third image 214 at the third time instance t3 to determine the presence or absence of bubbles 12 in the sample liquid 10. As shape of the bubbles 12 change with time, an additional image (i.e., the third image 214 captured at the third time instance t3) taken into account for detecting the bubbles 12 may further improve the accuracy of the process 700 implemented by the processor 20 of the system 100 of the automated analyzer 50. FIGS. 8A-8D are schematic views of the container 102 (also shown in FIG. 3) and the bubble removing unit 120 of the system 100 (shown in FIGS. 1 and 2), according to an embodiment of the present disclosure. The bubble removing unit 120 is configured to perform a bubble removing procedure for removing the bubbles 12 in the sample liquid 10. Therefore, if the processor 20 determines the presence of bubbles 12, the bubble removing unit 120 performs the bubble removing procedure for removing the bubbles 12 in the sample liquid 10. The bubble removing unit 120 is communicably coupled to the processor 20 (shown in FIG. 1).

The bubble removing unit 120 includes the sample probe 122 (also shown in FIG. 2) configured to selectively aspirate the sample liquid 10 from the container 102. The bubble removing unit 120 further includes a probe movement module 124 configured to selectively move the sample probe 122. Specifically, the probe movement module 124 selectively moves the sample probe 122 to contact the surface 14 of the sample liquid 10 upon determining the presence of bubbles 12 in the sample liquid 10. As illustrated in FIG. 8A, the sample probe 122 is in contact with the bubbles 12 and the surface 14 of the sample liquid 10. The sample probe 122 contacts the surface 14 of the sample liquid 10 to perform the bubble removal procedure. In other words, as the sample probe 122 contacts the surface 14 of the sample liquid 10, the bubbles 12 in the sample liquid 10 are removed due to contact of a probe tip with the bubbles 12.

When the sample probe 122 contacts the surface 14 of the sample liquid 10 to perform the bubble removal procedure, a level of the sample liquid 10 may also be sensed. In other words, the sample probe 122 contacts the surface 14 of the sample liquid 10 to perform the bubble removal procedure and also perform a first level sensing. In general, the level of the sample liquid 10 may be calculated by lowering the sample probe 122 into the sample liquid 10 such that the sample probe 122 contacts the surface 14 to remove the bubbles 12, and then detecting a pressure increase at a distal end 123 of the sample probe 122. Based on the pressure increase at the distal end 123, the level of the sample liquid 10 may be calculated. In some cases, while lowering the sample probe 122 into the sample liquid 10, the level of the sample liquid 10 may be calculated by determining a travel distance of the sample probe 122 until the pressure increase is detected. Based on the travel distance, the level of the sample liquid 10 may be calculated.

After the sample probe 122 performs the bubble removing procedure, the probe movement module 124 moves, without aspiration of the sample liquid 10, the sample probe 122 away from the surface 14 of the sample liquid 10. As illustrated in FIG. 8B, the sample probe 122 is away from the surface 14 of the sample liquid 10. The probe movement module 124 further moves the sample probe 122 to contact the surface 14 of the sample liquid 10, such that the sample probe 122 again senses the level of the sample liquid 10 upon contact with the surface 14 of the sample liquid 10. In other words, the probe movement module 124 further moves the sample probe 122 to contact the surface 14 of the sample liquid 10 and also perform a second level sensing of the sample liquid 10. As illustrated in FIG. 8C, the sample probe 122 is in contact with the surface 14 of the sample liquid 10. The sample probe 122 further aspirates at least a portion 129 of the sample liquid 10 from the container 102 after sensing the level (i.e., the second level sensing) of the sample liquid 10. As illustrated in FIG. 8D, the sample probe 122 aspirates at least the portion 129 of the sample liquid 10 from the container 102.

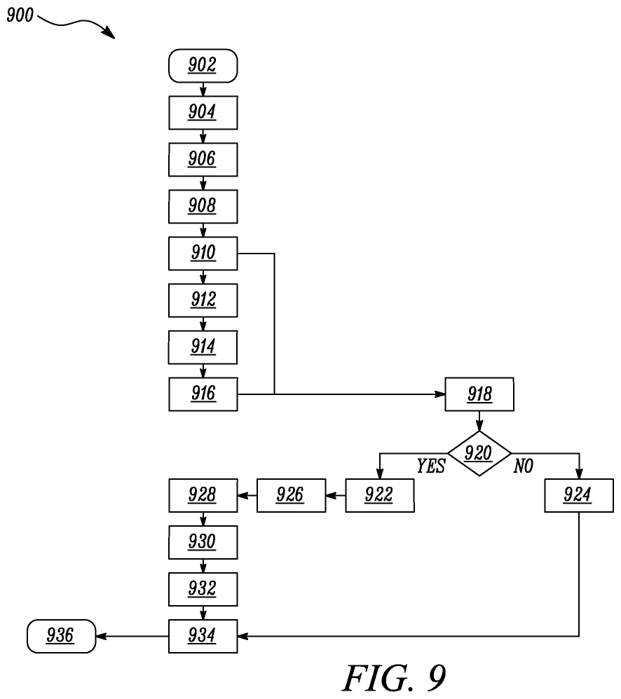

FIG. 9 is a flowchart of a process 900 to detect the bubbles 12 in the sample liquid 10 disposed in the container 102 (shown in FIG. 8A) and perform the bubble removing procedure by the bubble removing unit 120 (shown in FIGS. 8A-8D), according to an embodiment of the present disclosure. The process 900 is embodied as a machine vision algorithm or a machine learning algorithm implemented by the system 100 (shown in FIGS. 1 and 2) including the processor 20. Further, the process 900 may be stored in the memory 22.

At operation 902, the process 900 begins. In the process 900, operations 904, 906, 908, 910, 912, 914, 916, 918, 920, 922, and 924 are same as the operations 604, 606, 608, 610, 612, 614, 616, 618, 620, 622, and 624, respectively, of the process 600 of FIG. 6.

Upon determining the absence of bubbles 12 at the operation 924, the process 900 further moves to operation 934. At the operation 934, the processor 20 controls the bubble removing unit 120 or the probe movement module 124 to lower the sample probe 122 into the sample liquid 10 and aspirate (shown in FIG. 8D) at least the portion 129 of the sample liquid 10 from the container 102. The process 900 further moves to operation 936 where the process 900 is terminated.

Upon determining the presence of bubbles 12 at the operation 922, the process 900 moves to operation 926. Referring to FIGS. 1 to 5, and FIGS. 8A to 9, at the operation 926, the processor 20 controls the transport mechanism 110 to move the rack 104 and the container 102 from the second position P2 to a sampling position (not shown). In some cases, the sampling position of the container 102 is same as the second position P2 of the container 102. In such a case, the operation 926 may not take place and the sampling (i.e., aspiration) would be conducted at the second position P2 only. Also, after moving the rack 104 and the container 102 to the sampling position at the operation 926, the process 900 moves to the operation 928. At the operation 928, the processor 20 controls the bubble removing unit 120 or the probe movement module 124 to move the sample probe 122 to contact the surface 14 (shown in FIG. 8A) of the sample liquid 10. The sample probe 122 contacts the surface 14 of the sample liquid 10 to perform the bubble removal procedure and perform the first level sensing of the sample liquid 10. The process 900 further moves to operation 930.

At the operation 930, the processor 20 controls the bubble removing unit 120 or the probe movement module 124 to move, without aspiration of the sample liquid 10, the sample probe 122 away (shown in FIG. 8B) from the surface 14 of the sample liquid 10. In other words, at the operation 930, the sample probe 122 is moved away from the surface 14 without aspirating the sample liquid 10. The process 900 further moves to operation 932.

At the operation 932, the processor 20 controls the bubble removing unit 120 or the probe movement module 124 to move the sample probe 122 to contact the surface 14 (shown in FIG. 8C) of the sample liquid 10 and also perform the second level sensing of the sample liquid 10. After performing the second level sensing, the process 900 further moves to operation 934. At the operation 934, the processor 20 controls the bubble removing unit 120 or the probe movement module 124 to lower the sample probe 122 into the sample liquid 10 and aspirate (shown in FIG. 8D) at least the portion 129 of the sample liquid 10 from the container 102. The process 900 further moves to operation 936 where the process 900 is terminated.

With reference to FIGS. 1 to 5, and FIGS. 8A to 9, upon determining the presence of bubbles 12 in the sample liquid 10, the bubble removing unit 120 removes the bubbles 12 by using the probe movement module 124 and the sample probe 122. The processor 20 controls the bubble removing unit 120 to selectively move the sample probe 122 to remove the bubbles 12 as well as perform the first level sensing of the sample liquid 10. After a given time period, the processor 20 controls the bubble removing unit 120 to selectively move the sample probe 122 to perform the second level sensing of the sample liquid 10. After performing the two stages of level sensing (i.e., the first level sensing and the second level sensing) of the sample liquid 10, the processor 20 controls the bubble removing unit 120 to selectively move the sample probe 122 to aspirate an amount of the sample liquid 10 from the container 102. Therefore, by removing the bubbles 12 in the sample liquid 10, the system 100 including the processor 20 and the bubble removing unit 120 may facilitate continuous operation of testing a number of liquid samples without any erroneous test results. Moreover, as the bubbles 12 are removed by the sample probe 122 during its first contact with the surface 14 of the sample liquid 10, there is a minimal chance of a false level sensing of the sample liquid 10. The correct sensing of the level of the sample liquid 10 may prevent the aspiration operation from including a pipetting error that could otherwise generate false test results of the sample liquid 10.

FIGS. 10A and 10B are schematic views of the container 102 (also shown in FIG. 3) and the bubble deforming unit 125 of the system 100 (shown in FIGS. 1 and 2), according to an embodiment of the present disclosure. The bubble deforming unit 125 is configured to perform a bubble deforming procedure for deforming the bubbles 12 in the sample liquid 10. The bubble deforming unit 125 is communicably coupled to the processor 20 (shown in FIG. 1). In some embodiments, the bubble deforming procedure is a part of a process of detecting the bubbles 12 in the sample liquid 10. The bubble deforming procedure includes agitating the sample liquid 10 disposed in the container 102. In some embodiments, the bubble deforming unit 125 performs the bubble deforming procedure after the first time instance t1 (shown in FIG. 5) and before the second time instance t2.

In some embodiments, the bubble deforming unit 125 includes a vibrating mechanism 126 configured to vibrate the container 102. The vibrating mechanism 126 vibrates the container 102 to perform the bubble deforming procedure. In other words, the vibrating mechanism 126 vibrates the container 102 for agitating the sample liquid 10. In some embodiments, the vibrating mechanism 126 is coupled to a motor to receive a required power for vibration. In some cases, the vibrating mechanism 126 may include a motor shaft. In some cases, the vibrating mechanism 126 is a small electric motor with an eccentric weight fastened to a rotating shaft. In some cases, the vibrating mechanism 126 may include piezoelectric crystals.

As shown in FIG. 10A, the vibrating mechanism 126 is operatively coupled to the container 102 for agitating the sample liquid 10 and deforming the bubbles 12. After deforming the bubbles 12 in the sample liquid 10, shape of the bubbles 12 may change. FIG. 10B shows the container 102 after the bubble deforming procedure is performed by the vibrating mechanism 126. The shape of the bubbles 12 corresponding to FIG. 10B (after the bubble deforming procedure) differs from the shape of the bubbles 12 corresponding to FIG. 10A. Such change in the shape of the bubbles 12, caused by the bubble deforming procedure, may facilitate in the detection of the bubbles 12 in the sample liquid 10.

FIGS. 11A and 11B are schematic views of the container 102 (also shown in FIG. 3) and the bubble deforming unit 125, according to another embodiment of the present disclosure. In the illustrated embodiment of FIGS. 11A and 11B, the bubble deforming unit 125 includes a fluid delivery mechanism 128 configured to discharge a gaseous fluid (e.g., air). In some cases, the fluid delivery mechanism 128 may be a compressor. The fluid delivery mechanism 128 blows the gaseous fluid into the sample liquid 10 to perform the bubble deforming procedure. In other words, the fluid delivery mechanism 128 blows the gaseous fluid into the sample liquid 10 for agitating the sample liquid 10. The fluid delivery mechanism 128 blows the gaseous fluid into the sample liquid 10 through a hose 130 coupled to the fluid delivery mechanism 128.

As shown in FIG. 11A, the fluid delivery mechanism 128 blows the gaseous fluid for agitating the sample liquid 10 and deforming the bubbles 12. After deforming the bubbles 12 in the sample liquid 10, shape of the bubbles 12 may change. FIG. 11B shows the container 102 after the bubble deforming procedure is performed by the fluid delivery mechanism 128. The shape of the bubbles 12 corresponding to FIG. 11B (after the bubble deforming procedure) differs from the shape of the bubbles 12 corresponding to FIG. 11A.

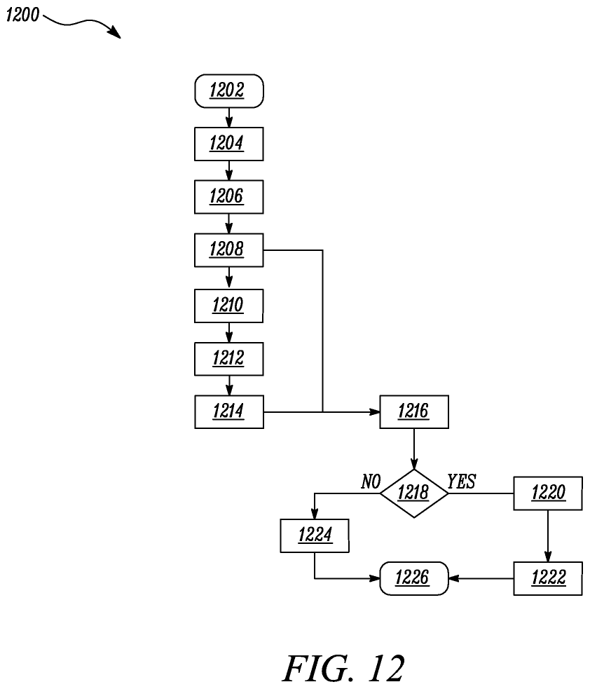

FIG. 12 is a flowchart of a process 1200 to detect the bubbles 12 in the sample liquid 10 disposed in the container 102 (shown in FIG. 8A) and perform the bubble deforming procedure by the bubble deforming unit 125 (shown in FIGS. 10A to 11B), according to an embodiment of the present disclosure. The process 1200 is embodied as a machine vision algorithm or a machine learning algorithm implemented by the system 100 (shown in FIGS. 1 and 2) including the processor 20. Further, the process 1200 may be stored in the memory 22.

At operation 1202, the process 1200 begins. In the process 1200, operations 1204, 1206, 1208, and 1210 are same as the operations 604, 606, 608, and 610, respectively, of the process 600 of FIG. 6. Referring now to FIGS. 1 to 5, and FIGS. 10A to 12, after the first image 210 is captured (operation 1210) at the first position P1 and at the first time instance t1, the process 1200 moves to operation 1212.

At the operation 1212, the processor 20 controls the bubble deforming unit 125 (shown in FIGS. 10A to 11B) to perform the bubble deforming procedure to deform the bubbles 12 in the sample liquid 10. In other words, the bubble deforming unit 125 performs the bubble deforming procedure by agitating the sample liquid 10 in the container 102. The bubble deforming procedure is performed at a position where the first image 210 of the container 102 is captured. Therefore, the bubble deforming unit 125 performs the bubble deforming procedure at the first position P1 of the container 102. The process 1200 further moves to operation 1214.

At the operation 1214, the processor 20 controls the image capture device 200 to capture the second image 212 (shown in FIG. 1) of the container 102 at the second time instance t2 after the first time instance t1. The second image 212 is therefore captured at the operation 1214 after performing the bubble deforming procedure. The second image 212 of the container 102 is captured from the top of the container 102. The process 1200 further moves to operation 1216.

At the operation 1216, the processor 20 compares the first image 210 with the second image 212 to determine the pattern matching score S1. The process 1200 further moves to operation 1218. At the operation 1218, the processor 20 compares the pattern matching score S1 with the predetermined threshold score S2 (shown in FIG. 1). Specifically, at the operation 1218, the processor 20 checks if the pattern matching score S1 crosses the predetermined threshold score S2. If the pattern matching score S1 does not cross the predetermined threshold score S2, the process 1200 moves to operation 1224.

At the operation 1224, the processor 20 determines the absence of bubbles 12 in the sample liquid 10. Thus, due to the absence of bubbles 12 in the sample liquid 10 disposed in the container 102, the sample liquid 10 may be aspirated and considered appropriate for use in the automated analyzer 50.

At the operation 1218, if the pattern matching score S1 crosses the predetermined threshold score S2, the process 1200 moves to operation 1220. At the operation 1220, the processor 20 determines the presence of bubbles 12 in the sample liquid 10. Thus, due to the presence of bubbles 12 in the sample liquid 10 disposed in the container 102, the sample liquid 10 may be considered inappropriate for use in the automated analyzer 50. The process 1200 further moves to operation 1222.

At the operation 1222, the processor 20 controls the output device 116 to provide an output indicating of the presence of bubbles 12 in the sample liquid 10. After providing the output, the process 1200 moves to operation 1226 where the process 1200 is terminated.

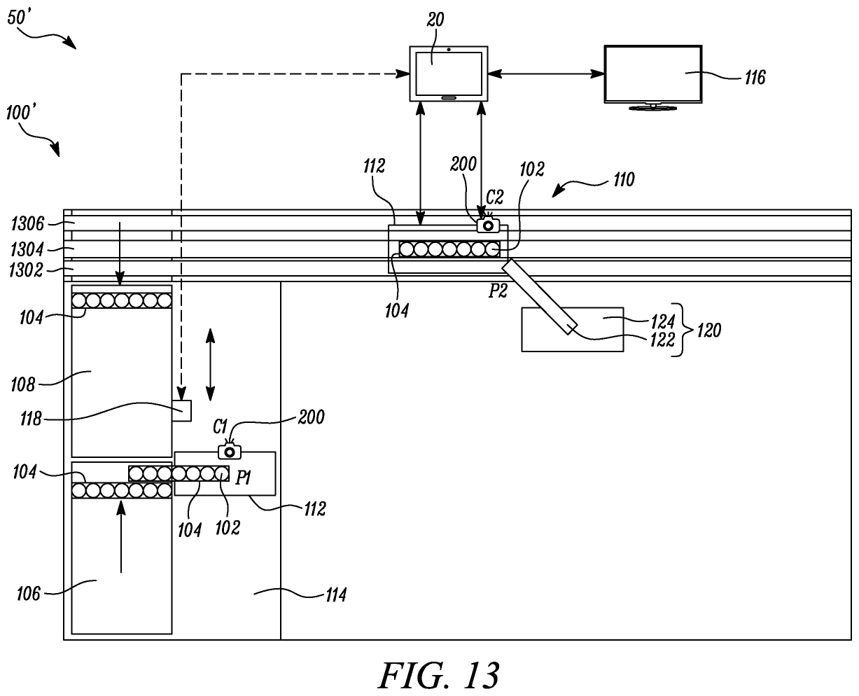

FIG. 13 is a schematic diagram of a system 100′ of an automated analyzer 50′ for detecting bubbles in a sample liquid, according to an embodiment of the present disclosure. The automated analyzer 50′ is a clinical analyzer. The system 100′ is substantially similar to the system 100 illustrated in FIG. 2, with common components being referred to by the same reference numerals. However, in the system 100′, the position of some components, such as the rack loading unit 106, the rack unloading unit 108, the reading device 118, the lane 114, the bubble removing unit 120, etc. are different from their respective positions in the system 100. Further, in the system 100′, locations of the first position P1, the second position P2, the first capture position C1, and the second capture position C2 may be different as compared to their respective locations in the system 100.

In addition to the lane 114, the system 100′ or the automated analyzer 50′ further includes a priority lane 1302 (short turnaround time or “STAT”), a routine lane 1304, and a return lane 1306. A rack loaded in the priority lane 1302 is given more priority for observation as compared to a rack loaded in other lanes. In some embodiments, the priority lane 1302 is directly connected to the lane 114. In some embodiments, the routine lane 1304 is directly connected to the lane 114. In the illustrated embodiment of FIG. 13, the second position P2 of the container 102 and the second capture position C2 of the image capture device 200 are located in the routine lane 1304.

In the system 100′ the transport mechanism 110 further includes a shuttle 112 that removably receives the rack 104 therein. In some cases, the shuttle 112 moves on a track with conveyor belts (not shown) along the different lanes (i.e., the lane 114, the routine lane 1304, and so on), such that the shuttle 112 also moves the rack 104 from one position to another position. In some cases, the shuttle 112 may also move along the lane 114 and the routine lane 1304 with the help of devices, such as a chain, a carriage, a lead screw, a linear motor, or combinations thereof. In some cases, the transport mechanism 110 may include a stepper motor to move the shuttle 112 carrying the rack 104 from one position to another. Therefore, the shuttle 112 of the transport mechanism 110 moves the rack 104 from the first position P1 (located in the lane 114) to the second position P2 (located in the routine lane 1304).

After the first image 210 is captured at the first position P1 and at the first time instance t1, the transport mechanism 110 including the shuttle 112 moves the rack 104 from the first position P1 (in the lane 114) to the second position P2 (in the routine lane 1304).

In some embodiments, the image capture device 200 (shown schematically in FIG. 13) is disposed on the shuttle 112. Therefore, as the shuttle 112 moves the rack 104 from the first position P1 to the second position P2, the image capture device 200 also moves from the first capture position C1 to the second capture position C2. Therefore, the system 100′ of the automated analyzer 50′ may not include an image movement module.

In some cases, in addition to the illustrated components and lanes, the automated analyzer 50′ may include some other components and lanes as well. Such components are not illustrated for illustrative purposes only. A functional advantage provided by the system 100′ to the automated analyzer 50′ is same as the functional advantage provided by the system 100 to the automated analyzer 50.

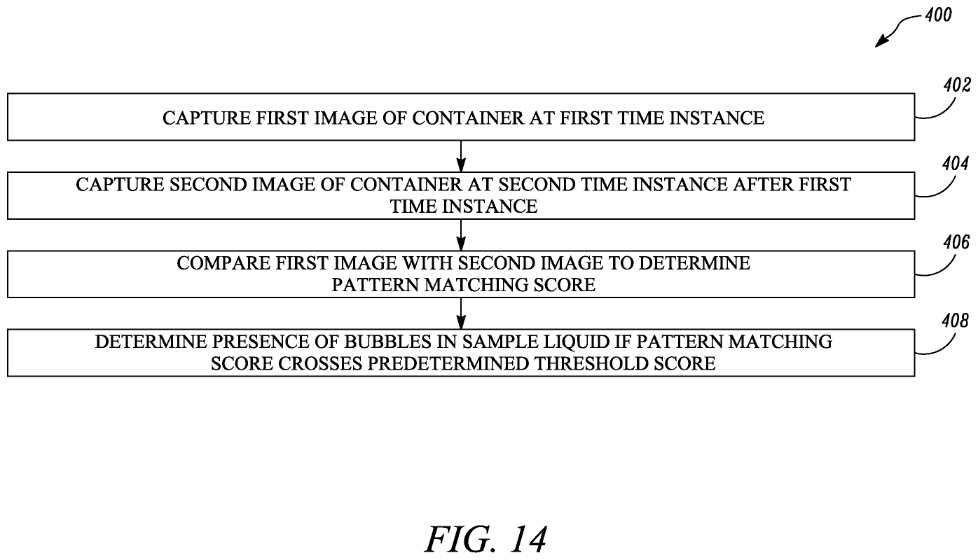

FIG. 14 is a flowchart illustrating a method 400 of detecting the bubbles 12 in the sample liquid 10 disposed in the container 102 (shown in FIG. 3), according to an embodiment of the present disclosure. The method 400 is implemented for use in the automated analyzer 50 of FIG. 2. The method can also be implemented for use in the automated analyzer 50′ of FIG. 13. The method includes operations 402, 404, 406, and 408.

With reference to FIGS. 1 to 5, 13, and 14, at operation 402, the image capture device 200 captures the first image 210 of the container 102 at the first time instance t1. In some embodiments, the first image 210 of the container 102 is captured at the first position P1 of the container 102. With reference to FIGS. 1 to 5, 10A to 11B, 13, and 14, in some embodiments, the method 400 further includes performing the bubble deforming procedure to deform the bubbles 12 in the sample liquid 10. The bubble deforming procedure includes agitating the sample liquid 10 by the bubble deforming unit 125. In some embodiments, the vibrating mechanism 126 (shown in FIG. 10A) vibrates the container 102 for agitating the sample liquid 10. In some embodiments, the fluid delivery mechanism 128 (shown in FIG. 11A) blows the gaseous fluid into the sample liquid 10 for agitating the sample liquid 10. The bubble deforming procedure is performed after the first time instance t1 and before the second time instance t2.

With reference to FIGS. 2, 13, and 14, in some embodiments, the image capture device 200 is disposed on the shuttle 112 (shown in FIG. 13). In some embodiments, the method 400 further includes moving the image capture device 200 between the first capture position C1 corresponding to the first position P1 of the container 102 and the second capture position C2 corresponding to the second position P2 of the container 102. In some cases, the image movement module 202 is configured to move the image capture device 200 from the first capture position C1 to the second capture position C2. In some embodiments, the reading device 118 reads the identifier associated with the container 102 at the first position P1 of the container 102.

With continued reference to FIGS. 2, 13, and 14, in some embodiments, the transport mechanism 110 moves the container 102 from the first position P1 to the second position P2 spaced apart from the first position P1. In some embodiments, the transport mechanism 110 moves the rack 104 from the first position P1 to the second position P2 in order to move the container 102 from the first position P1 to the second position P2. In some embodiments, the method 400 further includes moving the rack 104 from the first position P1 to the second position P2 along the lane 114. In some embodiments, the method 400 further includes moving the shuttle 112 (shown in FIG. 13) from the first position P1 to the second position P2 in order to move the rack 104 from the first position P1 to the second position P2. In some embodiments, the first position P1 is same as the second position P2. In such cases, the rack 104 may not be moved from the first position P1 at least for a time duration.

With reference to FIGS. 1 to 5, 13, and 14, at operation 404, the image capture device 200 captures the second image 212 of the container 102 at the second time instance t2 after the first time instance t1. In some embodiments, the second image 212 of the container 102 is captured at the second position P2 of the container 102. With reference to FIGS. 1 to 5, 7, 13, and 14, in some embodiments, the image capture device 200 captures the third image 214 of the container 102 at the third time instance t3 after the second time instance t2.

With reference to FIGS. 1 to 7, 13, and 14, at operation 406, the processor 20 compares the first image 210 with the second image 212 to determine the pattern matching score S1. In some embodiments, the processor 20 compares the first image 210, the second image 212, and the third image 214 with each other to determine the multi-image pattern matching score S3.

With continued reference to FIGS. 1 to 7, 13, and 14, at operation 408, the processor 20 determines the presence of bubbles 12 in the sample liquid 10 if the pattern matching score S1 crosses the predetermined threshold score S2. In some embodiments, the presence of bubbles 12 in the sample liquid 10 is determined if the pattern matching score S1 is greater than or equal to the predetermined threshold score S2. Similarly, the absence of bubbles 12 in the sample liquid 10 is determined if the pattern matching score S1 is less than the predetermined threshold score S2. In other embodiments, the presence of bubbles 12 in the sample liquid 10 is determined if the pattern matching score S1 is less than or equal to the predetermined threshold score S2. Similarly, the absence of bubbles 12 in the sample liquid 10 is determined if the pattern matching score S1 is greater than the predetermined threshold score S2. In some embodiments, the output device 116 provides the output indicative of the presence of bubbles 12 in the sample liquid 10 upon determining the presence of bubbles 12 in the sample liquid 10. In some embodiments, according to the process 700 of FIG. 7, the processor 20 determines the presence of bubbles 12 in the sample liquid 10 if each of the pattern matching score S1 and the multi-image pattern matching score S3 crosses the predetermined threshold score S2. Further, the processor 20 determines the absence of bubbles 12 in the sample liquid 10 if at least one of the pattern matching score S1 and the multi-image pattern matching score S3 does not cross the predetermined threshold score S2.

With reference to FIGS. 1 to 8D, 13, and 14, in some embodiments, the sample probe 122 (shown in FIG. 8A) aspirates the portion 129 of the sample liquid 10 upon determining the absence of bubbles 12 in the sample liquid 10. In some embodiments, the method 400 further includes performing the bubble removing procedure to remove the bubbles 12 in the sample liquid 10 upon determining the presence of bubbles 12 in the sample liquid 10. Referring to FIG. 8A, in some embodiments, the bubble removing procedure further includes moving the sample probe 122 to contact the surface 14 of the sample liquid 10 upon determining the presence of bubbles 12 in the sample liquid 10. Referring to FIG. 8B, in some embodiments, the method 400 includes moving, without aspirating the sample liquid 10, the sample probe 122 away from the surface 14 of the sample liquid 10 after performing the bubble removing procedure. Referring to FIG. 8C, the method 400 further includes moving the sample probe 122 to contact the surface 14 of the sample liquid (10) to sense the level of the sample liquid 10. Referring to FIG. 8D, the sample probe 122 aspirates at least the portion 129 of the of the sample liquid 10 from the container 102 after sensing the level of the sample liquid 10.

### Examples

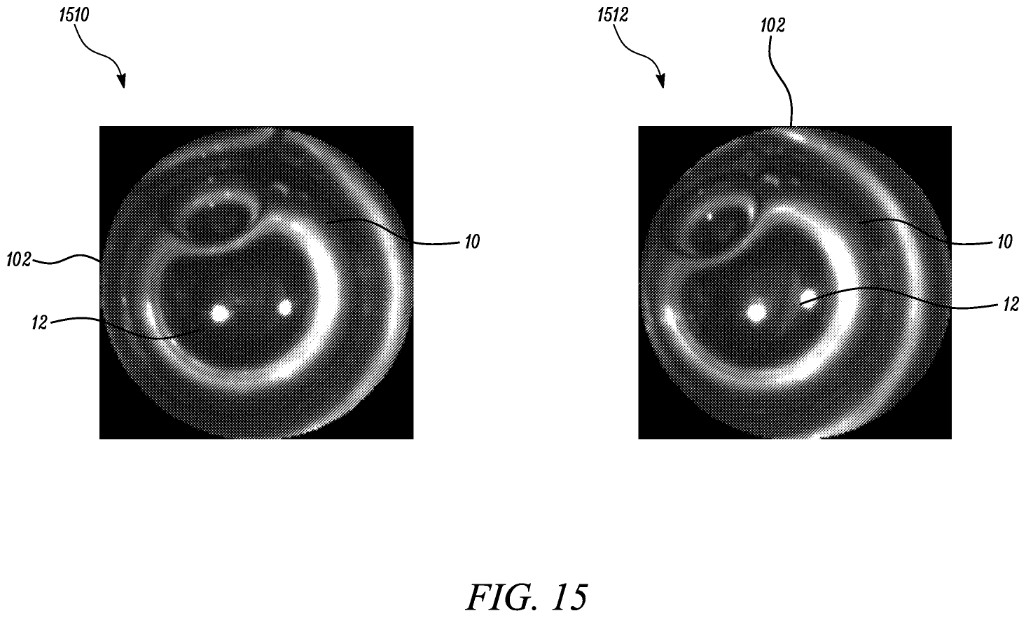

FIG. 15 shows a first image 1510 and a second image 1512 of the container 102 (also shown in FIG. 3) captured at different time instances during an experiment for detection of bubbles 12 in the sample liquid 10. The first image 1510 was captured at the first time instance t1 and the second image 1512 was captured at the second time instance t2 after the first time instance t1. Each of the first image 1510 and the second image 1512 was captured by the image capture device 200 (shown in FIG. 3) from the top of the container 102.

Referring to FIGS. 1, 6, and 15, the first image 1510 and the second image 1512 were compared with each other by the processor 20 to determine the pattern matching score S1. Table 1 shows the pattern matching score S1 determined during the experiment corresponding to FIG. 15. For this experiment, the pattern matching score S1 corresponds to an unmatching score of the first image 1510 and the second image 1512. The predetermined threshold score S2 was chosen as 30.

According to the process 600 of FIG. 6, if the pattern matching score S1 crosses the predetermined threshold score S2, the processor 20 determines the presence of bubbles 12 (shown in FIG. 15) in the sample liquid 10, and vice versa. The outcome of the experiment showed that the pattern matching score S1 (S1=85) crosses the predetermined threshold score S2 (S2=30). Therefore, in the experiment corresponding to FIG. 15, the processor 20 determined the presence of bubbles 12 in the sample liquid 10 disposed in the container 102. Consequently, the sample liquid 10 was considered inappropriate for use in an automated analyzer.

TABLE 1
Results of the experiment for detection
of bubbles in a sample liquid.

| | | Pattern | Predetermined |
|---|---|---|---|
| | Time | Matching | Threshold |
| Images | Instance | Score S1 | Score S2 |
| First Image 1510 | t1 | 85 | 30 |
| Second Image 1512 | t2 | | |

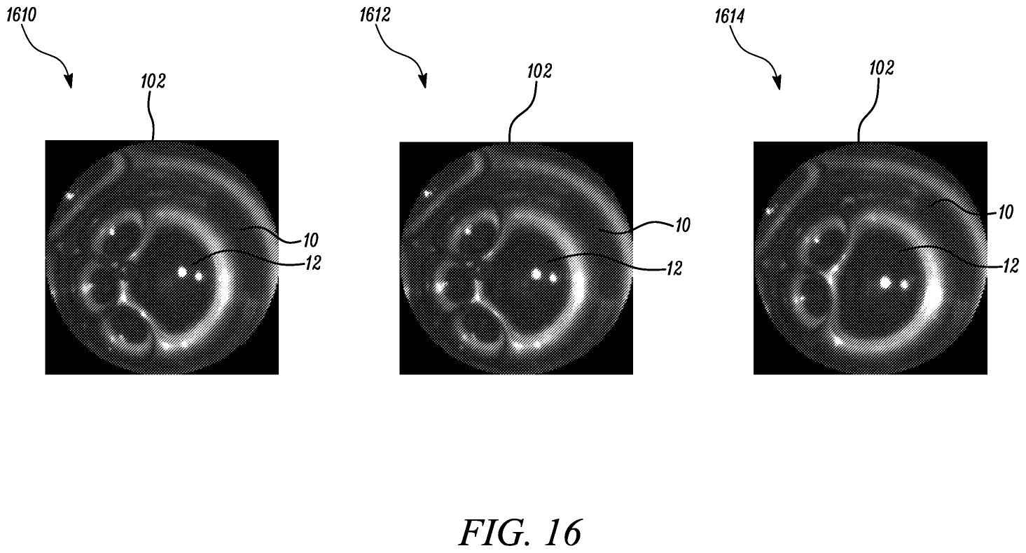

FIG. 16 shows a first image 1610, a second image 1612, and a third image 1614 of the container 102 (also shown in FIG. 3) captured at different time instances during an experiment for detection of bubbles 12 in the sample liquid 10. The first image 1610 was captured at the first time instance t1 and the second image 1612 was captured at the second time instance t2 after the first time instance t1. The third image 1614 was captured at the third time instance t3 after the second time instance t2. Each of the first image 1610, the second image 1612, and the third image 1614 was captured by the image capture device 200 (shown in FIG. 3) from the top of the container 102.

Referring to FIGS. 1, 6, 7, and 16, the first image 1610 and the second image 1612 were compared with each other by the processor 20 to determine the pattern matching score S1. Further, the first image 1610, the second image 1612, and the third image 1614 were compared with each other to determine the multi-image pattern matching score S3. Table 2 shows the pattern matching score S1 and the multi-image pattern matching score S3 determined during the experiment corresponding to FIG. 16. For this experiment, the pattern matching score S1 corresponds to an unmatching score of the first image 1610 and the second image 1612. For this experiment, the multi-image pattern matching score S3 also corresponds to an unmatching score of the first image 1610, the second image 1612, and the third image 1614. The predetermined threshold score S2 was chosen as 30.

According to the process 600 of FIG. 6, if the pattern matching score S1 crosses the predetermined threshold score S2, the processor 20 determines the presence of bubbles 12 (shown in FIG. 16) in the sample liquid 10, and vice versa. Further, according to the process 700 of FIG. 7, if each of the pattern matching score S1 and the multi-image pattern matching score S3 crosses the predetermined threshold score S2, the processor 20 determines the presence of bubbles 12 in the sample liquid 10.

The outcome of the experiment showed that the pattern matching score S1 (S1=59) crosses the predetermined threshold score S2 (S2=30). Further, the outcome of the experiment showed that the multi-image pattern matching score S3 (S3=98) also crosses the predetermined threshold score S2 (S2=30). Therefore, in the experiment corresponding to FIG. 16, the processor 20 determined the presence of bubbles 12 in the sample liquid 10 disposed in the container 102. Consequently, the sample liquid 10 was considered inappropriate for use in an automated analyzer.

TABLE 2
Results of the experiment for detection
of bubbles in a sample liquid

| | | | Multi-image | |
|---|---|---|---|---|
| | | Pattern | Pattern | Predetermined |
| | Time | Matching | Matching | Threshold |
| Images | Instance | Score S1 | Score S3 | Score S2 |
| First Image 1610 | t1 | 59 | 98 | 30 |
| Second Image 1612 | t2 | | | |
| Second Image 1614 | t3 | | | |

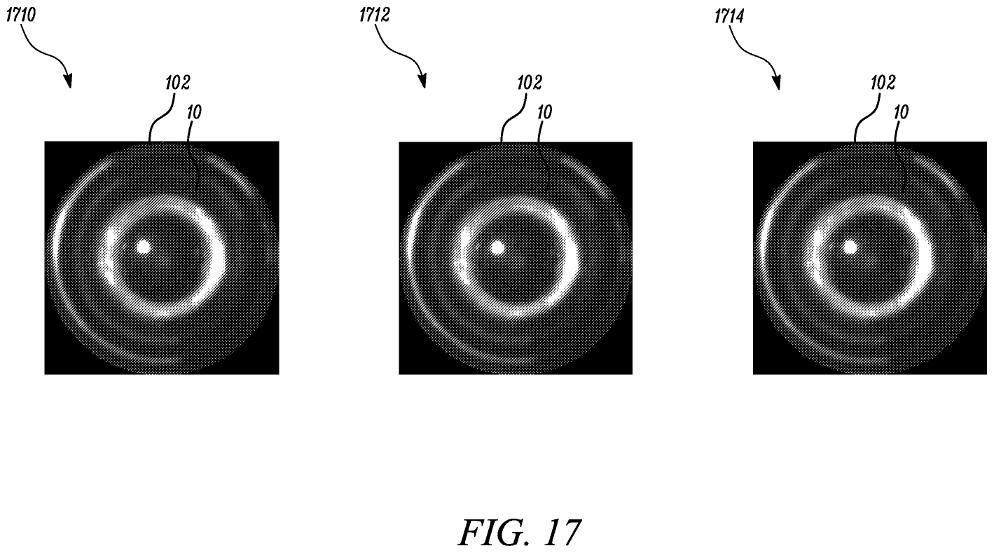

FIG. 17 shows a first image 1710, a second image 1712, and a third image 1714 of the container 102 (also shown in FIG. 3) captured at different time instances during an experiment for detection of bubbles in the sample liquid 10. The first image 1710 was captured at the first time instance t1 and the second image 1712 was captured at the second time instance t2 after the first time instance t1. The third image 1714 was captured at the third time instance t3 after the second time instance t2. Each of the first image 1710, the second image 1712, and the third image 1714 was captured by the image capture device 200 (shown in FIG. 3) from the top of the container 102.

Referring to FIGS. 1, 6, 7, and 17, the first image 1710 and the second image 1712 were compared with each other by the processor 20 to determine the pattern matching score S1. Further, the first image 1710, the second image 1712, and the third image 1714 were compared with each other to determine the multi-image pattern matching score S3. Table 3 shows the pattern matching score S1 and the multi-image pattern matching score S3 determined during the experiment corresponding to FIG. 17. For this experiment, the pattern matching score S1 corresponds to an unmatching score of the first image 1710 and the second image 1712. For this experiment, the multi-image pattern matching score S3 also corresponds to an unmatching score of the first image 1710, the second image 1712, and the third image 1714. The predetermined threshold score S2 is also provided in Table 3 and was chosen as 30.

According to the process 600 of FIG. 6, if the pattern matching score S1 crosses the predetermined threshold score S2, the processor 20 determines the presence of bubbles in the sample liquid 10, and vice versa. Further, according to the process 700 of FIG. 7, if each of the pattern matching score S1 and the multi-image pattern matching score S3 crosses the predetermined threshold score S2, the processor 20 determines the presence of bubbles in the sample liquid 10.

The outcome of the experiment showed that the pattern matching score S1 (S1=9) does not cross the predetermined threshold score S2 (S2=30). Further, the outcome of the experiment showed that the multi-image pattern matching score S3 (S3=25) does not cross the predetermined threshold score S2 (S2=30). Therefore, in the experiment corresponding to FIG. 17, the processor 20 determined the absence of bubbles in the sample liquid 10 disposed in the container 102. Consequently, the sample liquid 10 was considered appropriate for use in an automated analyzer.

TABLE 3
Results of the experiment for detection
of bubbles in a sample liquid

| | | | Multi-image | |
|---|---|---|---|---|
| | | Pattern | Pattern | Predetermined |
| | Time | Matching | Matching | Threshold |
| Images | Instance | ScoreS1 | Score S3 | Score S2 |
| First Image 1710 | t1 | 9 | 25 | 30 |
| Second Image 1712 | t2 | | | |
| Second Image 1714 | t3 | | | |

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1-54. (canceled)

55. A method of detecting bubbles in a sample liquid disposed in a container for use in an automated analyzer, the method comprising:
capturing, using an image capture device, a first image of the container at a first time instance;
capturing, using the image capture device, a second image of the container at a second time instance after the first time instance;
comparing, using a processor, the first image with the second image to determine a pattern matching score;
determining, using the processor, a presence of bubbles in the sample liquid if the pattern matching score crosses a predetermined threshold score; and
determining, using the processor, an absence of bubbles in the sample liquid if the pattern matching score does not cross the predetermined threshold score.

56. The method of claim 55, wherein the presence of bubbles in the sample liquid is determined if the pattern matching score is greater than or equal to the predetermined threshold score, and wherein the absence of bubbles in the sample liquid is determined if the pattern matching score is less than the predetermined threshold score.

57. The method of claim 55, wherein the presence of bubbles in the sample liquid is determined if the pattern matching score is less than or equal to the predetermined threshold score, and wherein the absence of bubbles in the sample liquid is determined if the pattern matching score is greater than the predetermined threshold score.

58. The method of claim 55, further comprising aspirating, using a probe, a portion of the sample liquid upon determining the absence of bubbles in the sample liquid.

59. The method of claim 55, further comprising performing a bubble deforming procedure to deform the bubbles in the sample liquid, wherein the bubble deforming procedure comprises vibrating, using a vibrating mechanism, the container and/or blowing, using a fluid delivery mechanism, a gaseous fluid into the sample liquid.

60. The method of claim 58, wherein the bubble deforming procedure is performed after the first time instance and before the second time instance.

61. The method claim 55, further comprising performing a bubble removing procedure to remove the bubbles in the sample liquid.

62. The method of claim 61, wherein the bubble removing procedure further comprises moving a sample probe to contact a surface of the sample liquid upon determining the presence of bubbles in the sample liquid.

63. The method of claim 62, further comprising:
moving, without aspirating the sample liquid, the sample probe away from the surface of the sample liquid after performing the bubble removing procedure;
moving the sample probe to contact the surface of the sample liquid to sense a level of the sample liquid; and
aspirating, using the sample probe, at least a portion of the sample liquid from the container after sensing the level of the sample liquid.

64. The method of claim 55, further comprising:
capturing, using the image capture device, a third image of the container at a third time instance after the second time instance;
comparing, using the processor, the first image, the second image, and the third image with each other to determine a multi-image pattern matching score; and
determining, using the processor, the presence of bubbles in the sample liquid if each of the pattern matching score and the multi-image pattern matching score crosses the predetermined threshold score.

65. The method of claim 55, further comprising providing, using an output device, an output indicative of the presence of bubbles in the sample liquid upon determining the presence of bubbles in the sample liquid, wherein the output comprises a notification for an operator to manually check for the bubbles in the sample liquid.

66. The method claim 64, wherein the output comprises a flagging result.

67. The method claim 64, wherein the output comprises a notification to halt at least any operation of the automated analyzer comprising a use of the sample liquid.

68. The method of claim 55, further comprising moving, using a transport mechanism, the container from the first position to the second position spaced apart from the first position, wherein the container is removably received in a rack, and wherein moving the container from the first position to the second position further comprises moving, using the transport mechanism, the rack from the first position to the second position.

69. The method of claim 68, wherein moving the rack from the first position to the second position further comprises moving the rack along a lane.

70. The method of claim 68, wherein the transport mechanism comprises a shuttle that removably receives the rack therein, and wherein moving the rack from the first position to the second position further comprises moving the shuttle from the first position (P1) to the second position.

71. The method of claim 70, wherein the image capture device is disposed on the shuttle.

72. The method of claim 71, further comprising reading, using a reading device, an identifier associated with the container at the first position of the container.

73. The method of claim 72, further comprising moving the image capture device between a first capture position corresponding to the first position of the container and a second capture position corresponding to the second position of the container.

74. The method of claim 73, wherein the first position is same as the second position.
